(19) United States
(12) Patent Application Publication
(10) Pub. No.: US 2025/0289434 A1
(43) Pub. Date: Sep. 18, 2025

(54) Method for Assisting a User of a Vehicle When Maneuvering the Vehicle on a Multi-Lane Road by Displaying an Intention for a Planned Lane Change Maneuver, and Driver Assistance System for a Vehicle

(71) Applicant: Bayerische Motoren Werke Aktiengesellschaft, Muenchen (DE)

(72) Inventors: Sami FAYAD, Muenchen (DE); Stephan NIERMANN, Hebertshausen (DE); Dominik RIETH, Muenchen (DE)

(21) Appl. No.: 18/860,523

(22) PCT Filed: Apr. 20, 2023
(86) PCT No.: PCT/EP2023/060262

§ 371 Date: Oct. 25, 2024

(30) Foreign Application Priority Data
Apr. 27, 2022 (DE) 10 2022 110 247.5

(51) Int. Cl. B60W 30/18; B60Q 1/34; G08G 1/16

(52) U.S. Cl. CPC B60W 30/18163; G08G 1/167; B60Q 1/346; B60W 2520/10; B60W 2540/30; B60W 2554/4049; B60W 2554/406; B60W 2720/12; B60W 2754/20

(57) ABSTRACT

A method for assisting a user of a vehicle when maneuvering the vehicle on a multi-lane road includes receiving a navigation command to guide the vehicle from a second lane of the road via a first lane of the road to an exit of the road. A lane change maneuver from the second lane to the first lane is prepared. Suitable gaps for the vehicle between further road users on the first lane to carry out the lane change maneuver are searched for. If no suitable gap is found, currently unsuitable gap with respect to the dimensions between the road users on the first lane is searched for. A driving maneuver and/or vehicle function is executed in such a way that an intention to carry out the lane change maneuver by the vehicle into the unsuitable gap is indicated to the road users delimiting the unsuitable gap.

### BACKGROUND AND SUMMARY

The present invention relates to a method for assisting a user of a vehicle when maneuvering the vehicle on a multi-lane road. In addition, the present invention relates to a driver assistance system for a vehicle.

Driver assistance systems for carrying out at least semiautomated lane change maneuvers or so-called lane change assistance systems are known from the prior art. In these driver assistance systems having automated or automatic lane change function, the user or driver typically indicates a desired lane change by a specific operating action. If such an operating action is detected, the vehicle is maneuvered by means of the driver assistance system along a planned trajectory on the adjacent lane or the target lane with automated lateral guidance and in general also with automated longitudinal guidance. With such driver assistance systems or lane change assistance systems, the driver-side lane change intention is typically signaled by actuating a corresponding operating element, for example, a turn signal lever, for activating direction indicators visible outside the vehicle.

Known driver assistance systems or lane change assistance systems generally monitor the surroundings of the vehicle before the lane change maneuver by means of suitable surroundings sensors. Upon the operating action of the user, the lane can be changed if a free gap for the ego vehicle has been detected on the adjacent lane. Such a free or suitable gap is dimensioned with respect to the dimensions such that the vehicle can be steered onto the target lane without risk of collision between the further road users.

In addition, driver assistance systems are known from the prior art which assist the user of the vehicle on a multi-lane road in reaching an exit. In this case, the driver assistance system can prepare all necessary lane changes until reaching an exit, for example, as a result of an input of a navigation destination. For this purpose, the driver assistance system can initially detect a suitable free gap for the vehicle on the adjacent lane and then adapt the speed of the vehicle for the following lane change maneuver into the detected gap. The lane change maneuver itself can be carried out by means of a lane change assistance system, wherein the lane change assistance system is triggered automatically or after an operating input by the user.

In dense road traffic and/or in congestion situations, the case can result that no suitable gap for the vehicle is found on the adjacent lane or the target lane. This can have the result that the lane change maneuver cannot be prepared by the driver assistance system and therefore the exit possibly can no longer be reached.

It is the object of the present invention to disclose a solution for how an operation of a driver assistance system of the type mentioned at the outset can be improved with respect to the preparation of lane change maneuvers.

This object is achieved according to the invention by a method and by a driver assistance system having the features according to the independent claims. Advantageous refinements of the present invention are specified in the dependent claims.

A method according to the invention is used to assist a user of a vehicle when maneuvering the vehicle on a multi-lane road. The method comprises receiving a navigation command to guide the vehicle from a second lane of the road via a first lane of the road to an exit of the road. In addition, the method comprises preparing a lane change maneuver from the second lane to the first lane. Furthermore, the method comprises searching for suitable gaps for the vehicle between further road users on the first lane to carry out the lane change maneuver. If no suitable gap for the vehicle is found on the first lane, the following steps are carried out: A gap which is currently unsuitable with respect to the dimensions is searched for between the road users on the first lane. In addition, at least one driving maneuver of the vehicle and/or at least one driving function of the vehicle is executed in such a way that an intention to carry out the lane change maneuver by the vehicle into the unsuitable gap is indicated to at least the road users or at least the further road users delimiting the unsuitable gap.

With the aid of the method, the user or driver of the vehicle is to be assisted when maneuvering the vehicle on a multi-lane road. The multi-lane road can in principle be a highway, a federal highway, an expressway, a freeway-like road, or the like. The multi-lane road is preferably a freeway. The road can have, for example, two directional roadways each having at least two lanes, which are referred to in the present case as the first lane and second lane. Both the ego vehicle and further road users can move in a specified direction of travel on these lanes. The road can also have further lanes. The first lane can adjoin an exit or a deceleration lane which leads to the exit. The first lane can be, for example, the right lane of a freeway.

The navigation command, which describes that the vehicle is to carry out a lane change maneuver to the first lane starting from the second lane, is received by means of the driver assistance system of the vehicle. Furthermore, the navigation command describes that the vehicle is to be maneuvered from the first lane via a deceleration lane to the exit of the road. In other words, initially a lane change from the second lane to the first lane is to be carried out and then the vehicle is to depart from the road via the exit. In addition, the vehicle can change from the road via the exit to another road. This can be the case, for example, at a freeway intersection or the like. In principle, the navigation command can be specified by routing or a navigation system of the vehicle. Alternatively, or additionally, the navigation command can be established by a corresponding operating input from the user.

Furthermore, the lane change or the lane change maneuver from the second lane to the first lane can be prepared by means of the driver assistance system. For this purpose, initially a search can be made for free gaps for the vehicle on the first lane using corresponding surroundings sensors of the driver assistance system or the vehicle. Free gaps can therefore be found between the further road users on the first lane which are suitable for the following lane change maneuver. A suitable gap can be dimensioned, for example, such that the vehicle can be steered or maneuvered with a high degree of certainty without collision onto the first lane between the further road users. This can mean, for example, that the free gap is significantly greater than the length of the vehicle with respect to the direction of travel. For example, the suitable gap can be larger with respect to the direction of travel or the vehicle longitudinal direction than the length of the vehicle plus a predetermined safety distance.

It can furthermore be provided that a speed or longitudinal speed of the vehicle is adapted to prepare for the lane change maneuver by means of the driver assistance system. In particular, the longitudinal speed of the ego vehicle can be reduced or adapted to the speed of the further road user on the first lane. For example, the longitudinal speed of the vehicle can be adapted in such a way that a difference between the longitudinal speed of the vehicle and the speed of the further road users falls below a predetermined limiting value.

When a suitable free gap for the vehicle has been found, a corresponding instruction can be output to the user to actuate the operating element or the turn signal lever. As a result of the actuation of the operating element, the lane change maneuver from the second lane to the first lane can then be triggered or initiated. The lane change maneuver can be carried out in an automatic or automated manner by means of the driver assistance system or a lane change assistance system.

In dense traffic and/or in congestion situations, the case can occur that no suitable gaps for the vehicle are found on the first lane. In such situations, however, it is nonetheless desirable for the lane change maneuver from the second lane to the first lane to be carried out before reaching the exit so that the vehicle can depart the road via the exit. If no suitable gap is found on the first lane for the vehicle, the invention provides for a currently unsuitable gap to be searched for between the road users on the first lane. This unsuitable gap in particular represents a gap between the further road users which is too small for the vehicle with respect to the dimensions in the direction of travel or in the vehicle longitudinal direction. This means that such an unsuitable gap can have dimensions in the longitudinal direction of the vehicle which are smaller than the vehicle length. Typically, a lane change maneuver cannot be carried out into an unsuitable gap using a lane change assistance system. In the case of such a currently unsuitable gap, it is presumed that it is currently too small or is not suitable with respect to the dimensions for a lane change maneuver, but at a later point in time the possibility for a lane change maneuver into this gap can result, however. This can take place, for example, due to the driving behavior of the road users delimiting this gap. For example, the further road users delimiting this unsuitable gap can adapt their longitudinal speed so that the gap becomes larger.

In addition, it is provided that for the case that no suitable gap is found on the first lane, at least one driving maneuver and/or at least one driving function is executed. The driving maneuver and/or the driving function is executed here in such a way that the intention is indicated to the further road users on the first lane and in particular the further road users on the first lane delimiting the unsuitable gap that the lane change maneuver into the unsuitable gap is to be carried out. In other words, the vehicle is to be maneuvered or functions and/or components of the vehicle are to be actuated in such a way that it is clearly indicated to the further road users that the vehicle wishes to carry out a lane change maneuver into the currently still unsuitable gap. The further road users and in particular the further road users delimiting this unsuitable gap can therefore influence the driving behavior in such a way that the currently unsuitable gap enlarges with respect to the spatial dimensions in relation to the direction of travel and this gap then becomes a suitable gap. Therefore, for example, the ego vehicle can still carry out the lane change maneuver into this gap and thus possibly still reaches the exit in a timely manner.

Preferably, an adaptation of the longitudinal speed, a reduction of a lateral distance of the vehicle to the first lane, and/or an activation of the direction indicator is executed as the at least one driving maneuver and/or as the at least one driving function. The term “driving maneuver” can be understood in principle as an intervention in the longitudinal guidance and/or lateral guidance of the vehicle by means of the driver assistance system. For example, the longitudinal speed of the vehicle can be adapted. In particular, the longitudinal speed of the vehicle can be reduced in order to indicate the intention for the planned lane change maneuver into the currently unsuitable gap to the further road users.

Alternatively, or additionally, it can be provided that the lateral distance of the vehicle to the first lane or the road users on the first lane is reduced as the driving maneuver. The lateral distance describes the distance in relation to the vehicle transverse direction in the direction to the first lane in this case. In other words, the distance to the further road users on the first lane or to the currently unsuitable gap can be reduced in order to indicate the intention for the planned lane change maneuver to the further road users.

The term “vehicle function” is understood in the present case in particular as any function of the vehicle which signals the planned lane change maneuver into the currently unsuitable gap to the further road users. In particular the direction indicators are preferably actuated or activated as the vehicle function. The planned lane change maneuver can be intuitively illustrated to the further road users delimiting the currently unsuitable gap by the above-described driving maneuver and/or vehicle functions.

It is preferably provided that the at least one driving maneuver and/or that the at least one driving function are provided with different escalation levels. These escalation levels or the selection of the escalation levels can take place in dependence on a setting, for example, a specification by the user. Alternatively, or additionally, the respective escalation levels can be determined in dependence on a speed of the vehicle, the current traffic density, a distance of the vehicle to the exit, or the like.

In one embodiment, it is provided that in a first escalation level the longitudinal speed of the vehicle is adapted such that the vehicle is located at the level of the unsuitable gap. In other words, the longitudinal speed of the vehicle can be adapted so that the vehicle, which is located on the second lane, moves adjacent to the currently unsuitable gap on the first lane. It is provided in particular here that the longitudinal speed of the vehicle is adapted or regulated in such a way that the vehicle follows this currently still unsuitable gap or is located at the level of the currently still unsuitable gap. In a first escalation level, the intention for the planned lane change maneuver can therefore be indicated to the further road users and in particular the further road users delimiting this currently still unsuitable gap.

In a further embodiment, in a second escalation level the lateral distance is reduced in such a way that the vehicle approaches a roadway marking between the first lane and the second lane and/or that the direction indicator is activated on the side of the vehicle facing toward the first lane. The second escalation level preferably comprises the driving maneuver from the first escalation level, according to which the longitudinal speed of the vehicle is reduced such that the vehicle is located at the level of the currently unsuitable gap. The second escalation level can be carried out in particular when after the first escalation level, the unsuitable gap has not changed to carry out the lane change maneuver. In the second escalation level, the lateral distance between the vehicle and the first lane or the currently still unsuitable gap can moreover be reduced. It is provided in this case that the vehicle approaches the roadway marking between the first and the second lanes upon the reduction of the lateral distance. In other words, it is provided that, upon the adaptation of the lateral distance, the second lane is not departed by the vehicle or the roadway marking is not driven over. Alternatively, or additionally, it can be provided that the direction indicators or the turn signals which face toward the first lane or the currently still unsuitable gap are activated. The intention can therefore be indicated in the second escalation level that the lane change maneuver into the currently still unsuitable gap is planned.

Furthermore, it is advantageous if, in a third escalation level, the lateral distance is adapted such that a roadway marking between the first lane and the second lane is driven over by the vehicle. In the third escalation level, the above-described driving maneuvers from the first escalation level and/or the second escalation level can be carried out. The third escalation level can be carried out in particular if the unsuitable gap has not changed to carry out the lane change maneuver after the first and/or the second escalation level. In comparison to the second escalation level, the lateral distance can be reduced, however, in such a way that the vehicle drives over the roadway marking between the first lane and the second lane with at least one wheel or tire. In other words, the vehicle can already be steered at least in some areas onto the first lane in the third escalation level in order to thus clarify the intention for the planned lane change maneuver into the currently still unsuitable gap. The vehicle can thus more or less force itself into the unsuitable gap.

In a further embodiment, the longitudinal speed is adapted once again and the at least one driving maneuver and/or the at least one driving function is executed in the case of a further unsuitable gap if the lane change maneuver into the unsuitable gap is not possible after expiration of a predetermined attempt duration. In other words, the vehicle can drop back and can carry out the above-described driving maneuvers and/or vehicle functions once again at a further unsuitable gap. The vehicle can thus drop back to the closest unsuitable gap and indicate the intention for the lane change maneuver into this gap here to the road users delimiting this further unsuitable gap. The predetermined attempt duration can describe the duration during which the driving maneuvers and/or vehicle functions are executed. The driving maneuvers and/or vehicle functions can be carried out here according to at least one of the above-described escalation levels. The predetermined attempt duration can be specified in dependence on the distance of the vehicle to the exit, on the current speed of the vehicle, on the traffic volume, on a driving behavior of the driver, or the like. In principle, it can also be provided that the vehicle drops back or reduces the speed multiple times and attempts the lane change maneuver in sequence at multiple unsuitable gaps.

Furthermore, it is advantageous if different vehemence levels are specified for the execution of the at least one driving maneuver and/or the at least one vehicle function in dependence on a driving behavior of the user and/or a current traffic situation. In principle, these vehemence levels can describe how clearly the intention is to be indicated to the further road users that the vehicle wishes to change into the unsuitable gap. These vehemence levels can be selected in dependence on the driving behavior of the user or the driver. For example, a low vehemence can be selected in the case of a rather restrained or fearful driver. However, a high vehemence can be selected in the case of a sporty or non-fearful driver. The driving behavior of the driver can be determined beforehand during journeys in which the user controls the vehicle manually. Alternatively, or additionally, it can be provided that the driving behavior can be set. Furthermore, the vehemence levels can be selected in dependence on the current traffic situation. For example, in the case of a very high traffic volume, a high vehemence level can also be selected. Moreover, the vehemence level can be selected in dependence on a distance of the vehicle to the exit, a current speed of the vehicle, or the like. The function of the driver assistance system can therefore be selected in dependence on the driving behavior of the driver and/or the current traffic conditions.

In a further embodiment, the vehemence levels differ from one another with respect to the executed escalation level and/or a duration passed between the escalation levels and/or the attempt duration. For example, at a low vehemence level, only the first and the second escalation level can be provided. At a higher vehemence level, all three above-described escalation levels can be provided. Moreover, the vehemence levels can differ with respect to the duration after which, for example, the higher escalation level is executed. At a low vehemence level this duration can be higher than at a higher vehemence level. Moreover, the vehemence levels can differ with respect to the attempt duration, after the passage of which the vehicle reduces the speed once again or drops back. For example, this attempt duration can be selected to be lower at a higher vehemence level than at a lower vehemence level. In this way, the operation of the driver assistance system can be provided in a situation-dependent manner.

Furthermore, it is advantageous if the vehemence levels differ with respect to speed profiles, wherein the speed profiles describe a course of the longitudinal speed in dependence on a distance of the vehicle to the exit. For example, at a low vehemence level, the at least one driving maneuver and/or the at least one driving function can already be started very early or from a long distance to the exit. At a higher vehemence level, the vehicle can move even farther on the current lane or the second lane at the current speed and can possibly reduce the speed at a later point in time. At a very high vehemence level, the longitudinal speed of the vehicle can be maintained as long as possible, wherein the vehicle is located on the second lane. The longitudinal speed can be reduced only shortly before reaching the exit and the intention can be indicated that a change is to be made into an unsuitable gap.

A driver assistance system according to the invention for a vehicle is configured to carry out a method according to the invention and advantageous embodiments thereof. The driver assistance system can in particular have a computing device, which can be formed by at least one electronic control unit. In principle, the computing device can have at least one processor and/or one memory.

The driver assistance system or the computing device is configured to receive the navigation command to guide the vehicle from a second lane of the road via the first lane of the road to an exit of the road. Moreover, the driver assistance system is configured to prepare the lane change maneuver from the second lane to the first lane and to search for suitable gaps for the vehicle between further road users on the first lane to carry out the lane change maneuver. If no suitable gap is found on the first lane, a gap which is currently unsuitable with respect to the dimensions can be searched for between the road users on the first lane by means of the driver assistance system. Furthermore, at least one driving maneuver and/or at least one driving function can be executed by means of the driver assistance system in such a way that a function for carrying out the lane change maneuver by the vehicle into the unsuitable gap is indicated at least to the road users delimiting the unsuitable gap.

A vehicle according to the invention comprises a driver assistance system according to the invention. The vehicle is designed in particular as a passenger vehicle.

The preferred embodiments presented with respect to the method according to the invention and the advantages thereof apply accordingly to the driver assistance system according to the invention and to the vehicle according to the invention.

Further features of the invention result from the claims, the figures, and the description of the figures. The features and combinations of features mentioned above in the description and the features and combinations of features mentioned hereinafter in the description of the figures and/or solely shown in the figures are usable not only in the respective specified combination, but also in other combinations or alone, without departing from the scope of the invention.

The invention will be explained in more detail on the basis of preferred exemplary embodiments and with reference to the appended figures.

### BRIEF DESCRIPTION OF THE DRAWINGS

FIG. 1 shows a schematic representation of a vehicle which has a driver assistance system for assisting a user when maneuvering the vehicle on a multi-lane road;

FIG. 2 shows the vehicle according to FIG. 1, which is located on a multi-lane road, wherein a lane change maneuver from a second lane to a first lane is being prepared;

FIGS. 3a to 3d show different driving maneuvers and/or vehicle functions which can be executed to indicate an intention for a lane change maneuver to further road users;

FIG. 4 shows a schematic representation of a target speed course and of speed limits; and

FIG. 5 shows the vehicle according to FIG. 1, which is located on a multi-lane road, wherein a lane change maneuver from a second lane to a first lane is to be prepared.

### DETAILED DESCRIPTION OF THE DRAWINGS

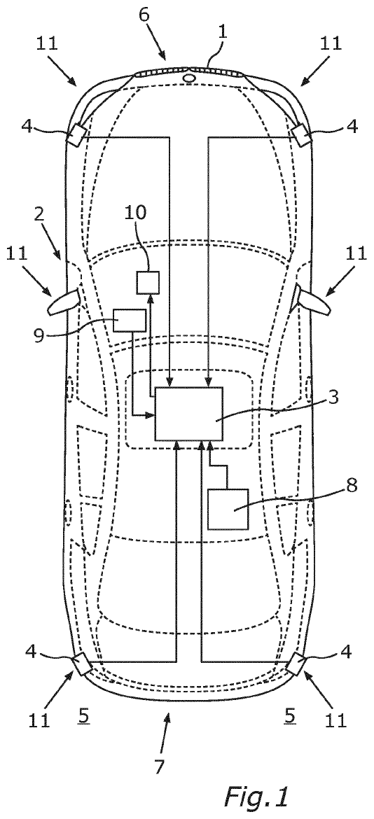

FIG. 1 shows a vehicle 1, which is designed in the present case as a passenger vehicle, in a top view. The vehicle 1 comprises a driver assistance system 2, by means of which a user can be assisted when carrying out lane change maneuvers. The driver assistance system 2 comprises a computing device 3, which can be formed, for example, by at least one electronic control unit.

In addition, the driver assistance system 2 comprises surroundings sensors 4. In the present exemplary embodiment, the driver assistance system 2 comprises four surroundings sensors 4, of which two surroundings sensors 4 are arranged in a front area 6 and two surroundings sensors 4 are arranged in a rear area 7 of the vehicle 1. The surroundings sensors 4 are arranged in the present case in the respective corners of the vehicle 1. The surroundings sensors 4 can preferably be designed as radar sensors. Corresponding measurements can be carried out using the surroundings sensors 4, in order to be able to detect objects and in particular further road users 13 in the surroundings 5 of the vehicle 1.

The computing device 3 is furthermore configured to receive a navigation command from a navigation system 8. Moreover, the computing device 3 is configured to detect an operating action carried out on an operating element 9 by a user. The operating element 9 can in particular be a turn signal lever. As soon as the turn signal lever or the operating element 9 is actuated by the user, corresponding direction indicators 11 of the vehicle 1 can be activated. In addition, the driver assistance system 2 comprises an output device 10, by means of which an instruction can be output to the user. This instruction can in principle be output optically, acoustically, and/or haptically.

The computing device 3 or the driver assistance system 2 is furthermore configured to actuate a drive motor and/or a braking system of the vehicle 1. The speed or longitudinal speed of the vehicle 1 can therefore be influenced. Moreover, it can be provided that the driver assistance system 2 or the computing device 3 can output control signals in order to be able to intervene in a steering system of the vehicle 1.

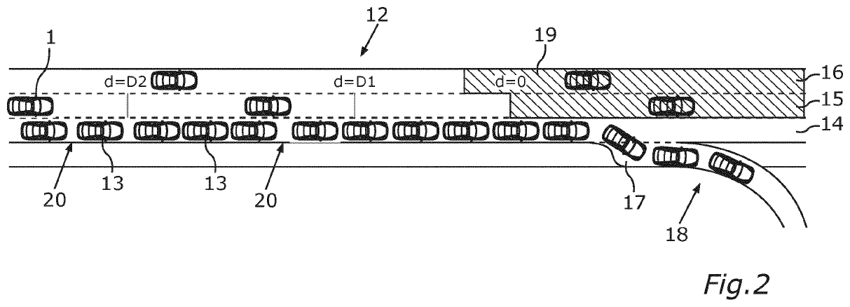

FIG. 2 shows the vehicle 1 which is located on a multi-lane road 12. The road 12 comprises a first lane 14, a second lane 15, and a third lane 16. In the present example, the vehicle 1 is located on the second lane 15 or the middle lane. On the basis of the navigation command, the vehicle 1 is to be maneuvered starting from the second lane 15 onto the first lane 14 and subsequently thereto via a deceleration lane 17 to an exit 18 of the road 12. Using the vehicle 1, a lane change maneuver is thus to be carried out from the second lane 15 to the first lane 14 and a further lane change maneuver is to be carried out from the first lane 14 to the deceleration lane 17.

Multiple road users 13 or further vehicles are located in the surroundings 5 of the vehicle 1. These further road users 13 can be detected on the basis of measurements using the surroundings sensors 4. In a very remote area 19 outside the detection range of the surroundings sensors 4, a presence of further road users 13 can be predicted on the basis of the recognized traffic density and/or on the basis of traffic information. In the example shown in FIG. 2, a small number of further road users 13 are located on the second lane 15, on which the ego vehicle 1 is also located. However, very many further road users are located on the target lane or the first lane 14.

In the present case, no suitable gap into which a lane change maneuver can be carried out using the vehicle 1 is present on the first lane 14. However, since the exit 18 is to be reached by the vehicle 1, it is provided that an initially (still) unsuitable gap 20 for the vehicle 1 is searched for. This currently still unsuitable gap 20 is not yet suitable for a lane change maneuver with respect to the dimensions in the direction of travel or in the vehicle longitudinal direction.

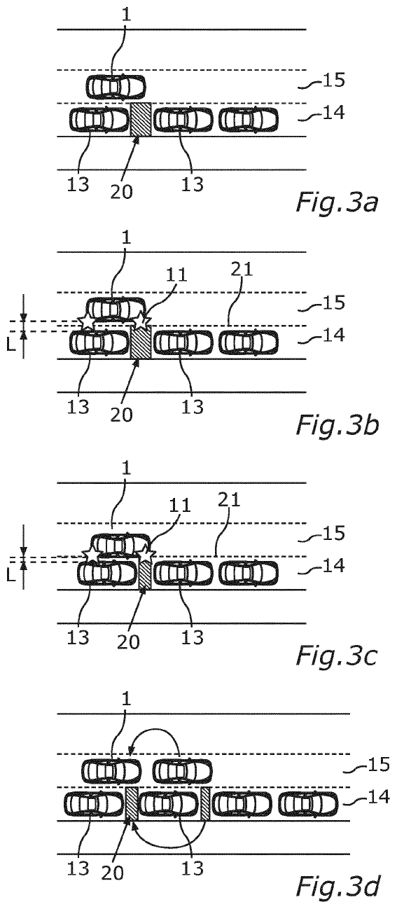

FIGS. 3a to 3d illustrate different driving maneuvers and/or executed vehicle functions, using which the intention is to be indicated to the further road users 13 on the first lane 14 that the vehicle 1 wishes to change into the currently still unsuitable gap 20. The situation according to FIG. 3a describes a first escalation level here. It is provided in this case that the vehicle 1, which is located on the second lane 15, adapts the longitudinal speed in such a way that the vehicle 1 is located or moves at the level of the currently still unsuitable gap 20. It can be indicated by this adaptation of the longitudinal speed to the further road users 13 delimiting this gap 20 that a lane change of the vehicle 1 from the second lane 15 to the first lane 14 is intended or planned.

FIG. 3b describes a second escalation level. In this case, it is provided in addition to the first escalation level according to FIG. 3a that a lateral distance L between the vehicle 1 and the first lane 14 is reduced. The lateral distance is adapted here in such a way that a roadway marking 21 between the first lane 14 and the second lane 15 is not driven over by the vehicle 1 in this case. Alternatively, or additionally, it can be provided that the direction indicators 11 are activated on the side of the vehicle 1 which faces toward the first lane 14.

FIG. 3c shows a third escalation level. The lateral distance L is moreover further reduced in comparison to the second escalation level according to FIG. 3b. In particular, the lateral distance L is reduced in such a way that the vehicle 1 passes over the roadway marking 21 between the first lane 14 and the second lane 15. The intention for the lane change maneuver can therefore be clearly indicated to the further road users 13 delimiting the still unsuitable gap 20.

FIG. 3d illustrates the dropping back of the vehicle 1 if the lane change maneuver into the still unsuitable gap 20 was not possible. This can be the case, for example, if at least one of the above-described escalation levels was carried out or a predetermined attempt duration has passed. In this case, the longitudinal speed of the vehicle 1 can be reduced once again and a further unsuitable gap 20′ can be searched for. At this further unsuitable gap 20′, the intention according to at least one type of the above-described escalation levels can then be indicated to the further road users 15 delimiting this gap 20′.

Different vehemence levels can also be provided for the operation of the driver assistance system 2 or for the preparation of the lane change maneuver. These vehemence levels can differ with respect to the clarity with which the intention for the planned lane change maneuver is indicated. For example, at a first vehemence level, the preparation of the lane change maneuver can be started as soon as it has been recognized that no suitable gap for the vehicle 1 is present. A comfortable speed reduction to the speed of the further road users 13 on the first lane 14 can be carried out immediately here. As soon as a speed difference between the speed of the ego vehicle 1 and the further road users 13 falls below a limiting value, a regulation to the gap 20 for the first time according to the first escalation level can be provided. After passage of a time constant for this first vehemence level, the second escalation level can be carried out if the gap 20 for the vehicle is large enough for the first time. After passage of the time constant for the first vehemence level, the dropping back of the vehicle 1—as described in conjunction with FIG. 3d—can then be carried out. This can be repeated until an abort distance d=0 is reached.

At a second vehemence level, the speed of the vehicle 1 can be maintained up to a distance d=D1 until the exit 18. Up to a distance D1, the speed or longitudinal speed of the vehicle 1 can be reduced, wherein the speed reduction can be carried out in dependence on experiential values in the case of the current traffic constellation. For example, the speed can be reduced so that dropping back between two and three road users 13 on the first lane 14 takes place. As soon as the speed difference permits it, it is possible to start with the first escalation level. After passage of a time constant for the second vehemence level, the second escalation level can be initiated. In turn after passage of this time constant for the second vehemence level, the third escalation level can be initiated. Subsequently thereto, the vehicle 1 can drop back to a further unsuitable gap 20′. The steps can also be carried out here until the abort distance d=0 is reached.

At a third vehemence level, the speed or longitudinal speed of the vehicle 1 can be maintained up to a distance d=D2. From the distance D1, the speed can be reduced, wherein the goal exists of maintaining the speed of the vehicle 1 as much as possible until the abort distance d=0. As soon as the speed difference permits it, it is possible to start with the first escalation level. After passage of a very small time constant for the third vehemence level, it is then possible to change to the second escalation level. In turn after passage of this time constant for the third vehemence level, it is possible to change to the third escalation level. The position or speed of the vehicle 1 can be maintained here until the abort distance d=0 is reached, since dropping back is no longer possible in this case.

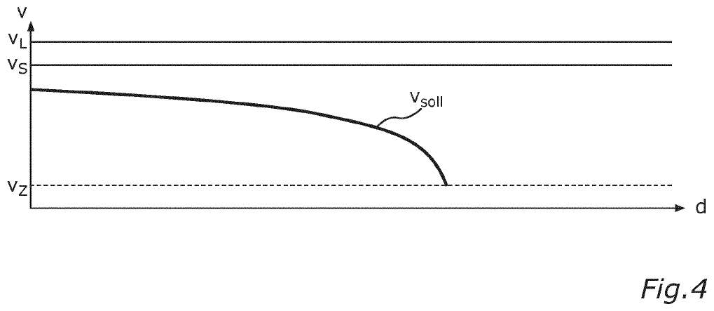

FIG. 4 shows a schematic representation of a possible speed course for the vehicle 1 until reaching the exit 18 for the traffic situation according to FIG. 2. In the diagram according to FIG. 4, the distance d until reaching the exit 18 is shown on the abscissa. The speed v or the longitudinal speed is plotted on the ordinate. In this case, v_{Z} describes a target speed which is to be reached by the vehicle 1 upon reaching the exit 18. The curve vₛₒₗₗ describes a target speed which can be specified beforehand. This can describe the speed course of the vehicle 1 starting from the current position until reaching the exit 18. In addition, hard limits or speed limits which cannot be exceeded are given by a set speed v_{S}, which can be specified by the user for a cruise control, and a maximum permissible highest speed v_{L}.

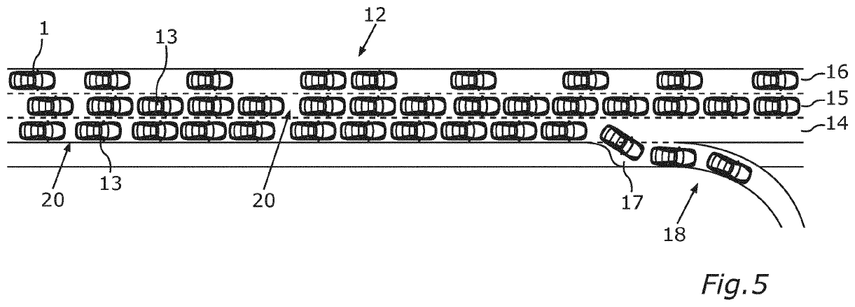

FIG. 5 shows the vehicle 1 in a traffic situation on a multi-lane road 12 according to a further embodiment. In the present case, the vehicle 1 is located on the first lane 16 or the left lane. A high traffic volume prevails on the road 12 and in particular traffic congestion is present on the first lane 14 and the second lane 15. Two lane change maneuvers are to be carried out here from the third lane 16 to the second lane 15 and from the second lane 15 to the first lane 14. The goal here is to carry out a respective lane change maneuver into the currently still unsuitable gaps 20 in order to reach the exit 18. At the first vehemence level, for example, the required lane change can be carried out as quickly as possible. At the third vehemence level, the vehicle 1 can be moved as long as possible on the third lane, wherein an attempt is provided with all possible escalation levels for each of the respective lane change maneuvers into the currently unsuitable gaps 20.

1-10. (canceled)

11. A method for assisting a user of a vehicle when maneuvering the vehicle on a multi-lane road, comprising:
receiving a navigation command to guide the vehicle from a second lane of the road via a first lane of the road to an exit of the road;
preparing a lane change maneuver from the second lane to the first lane;
searching for suitable gaps for the vehicle between further road users on the first lane to carry out the lane change maneuver; and
in response to no suitable gap being found on the first lane:
searching for a gap currently unsuitable with respect to the dimensions between the road users on the first lane, and
executing at least one driving maneuver and/or at least one vehicle function in such a way that an intention to carry out the lane change maneuver by the vehicle into the unsuitable gap is indicated at least to the road users delimiting the unsuitable gap.

12. The method of claim 11, wherein an adaptation of the longitudinal speed, a reduction of the lateral distance of the vehicle to the first lane, and/or an activation of direction indicators is executed as the at least one driving maneuver and/or as the at least one vehicle function.

13. The method of claim 12, wherein, in a first escalation level, the longitudinal speed of the vehicle is adapted such that the vehicle is located at the level of the unsuitable gap.

14. The method of claim 13, wherein, in a second escalation level, the lateral distance is reduced such that the vehicle approaches a roadway marking between the first lane and the second lane and/or that the direction indicators are activated on a side of the vehicle facing toward the first lane.

15. The method of claim 14, wherein in a third escalation level, the lateral distance is adapted such that the roadway marking between the first lane and the second lane is driven over by the vehicle.

16. The method of claim 11, wherein, if the lane change maneuver into the unsuitable gap is not possible after passage of a predetermined attempt duration, the longitudinal speed is adapted once again and the at least one driving maneuver and/or the at least one vehicle function is executed at a further unsuitable gap.

17. The method of claim 11, wherein various vehemence levels are specified for the execution of the at least one driving maneuver and/or the at least one vehicle function in dependence on a driving behavior of the user and/or a current traffic situation.

18. The method of claim 17, wherein the vehemence levels differ from one another with respect to the executed escalation level and/or a duration passed between the escalation levels and/or the attempt duration.

19. The method according to claim 17, wherein the vehemence levels differ with respect to speed profiles, wherein the speed profiles describe a course of the longitudinal speed in dependence on a distance of the vehicle to the exit.

20. A driver assistance system for a vehicle, wherein the driver assistance system is configured to carry out a method according to claim 11.
